(19) United States
(12) Patent Application Publication
(10) Pub. No.: US 2011/0301903 A1
(43) Pub. Date: Dec. 8, 2011

(54) SENSOR CALIBRATION IN AN RFID TAG

(75) Inventors: Arelie Humbert, Bruxelles (BE); Gilbert Curatola, Korbek-Lo (BE); Matthias Merz, Leuven (BE); Remco Henricus Wilhelmus Pijenburg, Hoogeloon (NL); Romano Hoofman, Geel (BE); Youri Ponomarev, Leuven (BE)

(73) Assignee: NXP B.V., Eindhoven (NL)

(21) Appl. No.: 12/992,824

(22) PCT Filed: Apr. 30, 2009
(86) PCT No.: PCT/IB2009/051758

§ 371 Date: Aug. 26, 2011

(30) Foreign Application Priority Data
May 15, 2008 (EP) 08103968.7

(51) Int. Cl. G01D 18/00

(52) U.S. Cl. 702/104

(57) ABSTRACT

A sensor, electrically connected to transponder, is calibrated in an environment of operational use of the transponder. The calibrating uses as a reference a value of a parameter representative of the environment.

### FIELD OF THE INVENTION

The invention relates to a method of calibrating a sensor electrically connected to a transponder.

### BACKGROUND ART

Over 600 million RFID (radio frequency identification) tags were delivered in 2005. Applications of such tags range from identification and access control to counterfeit prevention and logistics. Supply chain monitoring is a huge market for active tags equipped with sensor and memory to store the measured data. For example, tags with a temperature sensor constantly record the actual temperature of frozen food or goods that need to be cooled. Depending on the “thermal budget”, i.e. the temperature integrated over time during storage and transport, the shelf-life of the product is calculated on an individual basis. Moreover, the tags can indicate if certain limits, e.g. maximum or minimum temperature, have been exceeded and if the product must be discarded. Besides temperature, there are numerous other variables such as pH and gas composition that are characteristic for the quality of a product.

Because of variability in the manufacturing process, physical as well as chemical, most sensors need to be calibrated before use. This is generally done by exposing the sensor to defined conditions and measuring its output. Both output data as well as actual conditions are saved in a calibration file, which is used later to calculate the physical/chemical variables from the sensor reading. In order to increase accuracy, several calibration points are usually taken within a certain range and values in between are calculated from a calibration curve fitted to the data. In case of a thermometer with a temperature range 0° C.-100° C. the following three-point calibration procedure could apply. Cool the sensor to 10° C. and measure its reading (e.g., its Ohmic resistance), heat up the sensor to 50° C. and 90° C. and measure again. Fit to the data a calibration curve that reflects the main characteristics of the sensor (e.g., linear temperature/resistance relation in case of platinum temperature sensor).

US patent application publication US2004/0036626, herein incorporated by reference, relates to RFID systems and to interrogators for use with such systems capable of determining identification and/or other information from a tag. This publication discloses that, in one embodiment, the operations for testing, tuning, calibrating and programming of the transponder are performed using an automatic tester during the manufacturing process, while the integrated circuits are still on the semiconductor wafer used for fabrication. Testing, calibration, tuning and programming may thus be completed relatively quickly and easily by the automatic test equipment during the manufacturing process, eliminating the need to individually test and calibrate each completely packaged transponder. Alternatively, the operations may be performed at other times, such as after assembly of the integrated circuit into packages, or after the integrated circuits are cut into dies but before packaging.

International Application Publication WO2003/098175, incorporated herein by reference, relates to a system that includes a passive RFID tag, and a control device, such as an active smart RFID tag or RFID reader/writer that can communicate with the passive tag giving it energy and receiving data from it and that can analyze and store data so received. In the case of this control device being an active smart RFID tag, the system would further require a reader/writer that can instruct the active RFID tag and can read data created during use of the tags. The master tag can be pre-programmed at the time of manufacture or can be programmed prior to use using the RF writer/reader. At programmed intervals, the temperature data calculated from the frequency shift during data transmission sessions by the slave tag are stored in the master tag's data memory. The stored temperature data can be downloaded via RF writer/reader by someone interested in the temperature to which the container contents have been exposed. The slave tag comprises a procedure memory programmed with calibration data. The relationship between temperature and frequency would be calibrated prior to use and stored in the procedure memory of the master tag. It could also be stored in the slave tag's procedure memory, instead of or part of its identifier. In use, the slave tag is placed inside a container at the time of shipping or at the time of manufacture of such container. The master tag is placed outside the container in close proximity, such as attached to the container by adhesive or other means. The master tag is programmed to cause the slave tag to transmit data to it at intervals of interest to the user. Calibration data for the slave tag's temperature-frequency relationship will be stored either in the slave tag's or master tag's memory, and the difference in frequency from the transmitted RF signal to the received RF signal will be applied to the calibration data to determine the temperature at the slave tag. This will be time stamped and recorded in the master tag's data memory, or possibly in the slave tag's memory. To calibrate the slave tag's temperature-frequency relationship is determined under two or more specific temperatures. To achieve this, the slave tag could be inserted into a temperature insulated chamber containing a thermoelectric element. The temperature could be changed rapidly and with precision, allowing the measurement points to be determined. The specific function can then be calculated for this tag sample and stored in the procedure memory of the slave tag, from which it would be downloaded to the master tag or writer/reader to be used in temperature determination. This would obviate the necessity of uniquely pairing slave and master tags. The temperature-frequency function might equally be stored in the procedure memory of the master tag if specific master-slave pairs are to be used. From this function the temperature can be computed for any frequency values.

US Patent Application Publication 2007/0029388, incorporated herein by reference, discloses a sensor calibration system with a sensor having one or more sensing components formed on a substrate. A barcode can also be formed on the substrate. The barcode contains calibration data associated with a calibration of the sensor and the sensing component(s). One or more barcode readers can be provided which can scan the barcode and read the calibration data associated with the calibration of the sensor and the sensing components thereof, in order to reduce the need for trimming the sensor while also providing for a reduction in associated manufacturing and production costs.

US patent Application Publication 2006/0006987, incorporated herein by reference, discloses an RFID tag reader/writer that receives temperature data from a temperature sensor and writes the temperature data in one or more RFID tags. The temperature sensor may be attached to a commodity or arranged near the commodity. The RFID tag reader writer is an apparatus that reads out data from the RFID tag and writes data in the RFID using radio. The temperature sensor is a sensor incorporated in, or connected to, the RFID tag reader writer. The sensor measures temperature in the freezing warehouse, in which the RFID tag reader writer is set. The RFID tag can thus be used to maintain a history log of the temperatures to which the sensor of the RFID tag reader writer has been exposed.

International Application Publication WO2006/086263 discloses a one-point-calibration integrated temperature sensor for wireless radio frequency applications. The sensor uses two current sources supplying first and second currents of different magnitude to two diodes of first and second sizes that are different. The difference in voltages across two diodes is proportional to the absolute temperature, proportional to a device- and process-dependent parameter, and proportional to the logarithm of the product of the ratio of the first and second currents and the ratio of the second and first sizes. As a result, the known sensor can be calibrated at a single chosen temperature point, giving a single value of the calibration parameter. This reduces the cost of manufacture of the RFID sensor. The calibration parameter value can be stored on the RFID sensor chip itself or in a database that contains the chip's unique identifier.

International Application Publication WO2006/026748 relates to a sensor that, when exposed to a fluid, develops a measurable characteristic that is a function of the level of an analyte in the fluid and of a calibration quantity of the sensor. A calibration quantity is some physical, chemical or other inherent property that the sensor possesses that affects its response to the analyte. The sensor includes an RFID tag that receives, stores and conveys information representing the calibration quantity. The wireless device is incorporated into or attached to the sensor during the manufacturing process and before the sensor is calibrated. The wireless device can be written wirelessly once the calibration has been done. This does not involve any additional handling of the sensor and can be done once the sensor has been placed into a protective enclosure. Because of this, the process of wirelessly transmitting the calibration information to the wireless device does not alter any pre-existing calibration quantities and neither does it introduce any new calibration quantities, thus preserving the calibration of the sensor even though the sensor has been wirelessly modified to carry information representing its calibration quantity. This publication discloses a method of manufacturing a sensor that, when exposed to a fluid, develops a measurable characteristic that is a function of the level of an analyte in the fluid and of a calibration quantity of the sensor, and has a wireless device adapted to receive, store and convey information representing the calibration quantity. The method comprises: at least partly manufacturing the sensor so that it possesses the calibration quantity and includes the wireless device; then wirelessly transmitting the information representing the calibration quantity to the wireless device; and then, optionally, completing the manufacture of the sensor. When sensors are batch-manufactured, in either a flat-bed or staged process or in a continuous process, information representing the same calibration quantity may be transmitted to the wireless devices of a plurality of sensors at once or virtually simultaneously. In particular, a plurality of sensors may be placed into a protective enclosure and then information representing the same calibration quantity may be wirelessly transmitted to the wireless devices of that plurality of sensors at once or virtually simultaneously. This saves time and ensures the sensors are handled to the minimum degree possible.

### SUMMARY OF THE INVENTION

A calibration procedure typically includes checking, adjusting or determining a numerical value by comparison with a standard or another reference. As is known in the art, calibration processes are time-consuming and require special equipment. Related costs are usually commercially not relevant for high-precision sensors, but they are a major factor for ultra-low cost applications such as RFID tags used in, e.g., supply chain monitoring. The invention aims to minimize or even eliminate these calibration costs.

In the known approaches mentioned above, calibration is an additional process step that is either part of the manufacturing of the sensor itself, or of the assembly of the device that incorporates the sensor. In some cases, sensors are calibrated regularly, especially for high-precision applications or where drift is a great concern.

The inventors propose to calibrate the sensor of a transponder, e.g., a sensor in an RFID tag, during its use rather than in an extra calibration step at the manufacturer, thus saving the related cost. Initial conditions of many products, which are to be monitored by a sensor, are well defined and known to the manufacturer of the products. Examples of such initial conditions include the following: the temperature in the refrigerated warehouse, where the products are stored between production and shipment; the pH-value of a liquid such as milk and wine; the composition of gasses in a container that has been packed under controlled environmental conditions. These well-defined conditions can be used as reference for sensor calibration. Since a main purpose of supply chain sensor tags within above scenarios is to monitor a temperature profile or to measure the gradual increase in pH or of certain gasses as the products deteriorate, absolute accuracy is not so important and a single, one-point calibration is sufficient. In the invention, this calibration point is provided be the analyte itself.

More specifically, the invention relates to a method of calibrating a sensor electrically connected to a transponder. The method comprises calibrating the sensor in an environment of operational use of the transponder, wherein the calibrating uses as a reference a value of a parameter representative of the environment.

Accordingly, in the invention, the sensor is being calibrated against a reference that itself is characteristic of the very environment of the sensor's operational use. This has the advantage to the manufacturer of the sensor and/or of the combination of sensor and transponder, that the calibration step is not part of the manufacturing process, thus reducing costs. The cost savings are especially relevant to ultra-low cost transponders such as RFID tags. The calibration in operational use also has, in some scenarios, the advantage to the end-user of the transponder, in that the calibration is carried out with a very well defined reference at the very value of the physical or chemical quantity that the sensor is going to be monitoring, avoiding the need for intricate interpolation or extrapolation curves, if excursions around the reference are monitored that are small enough to warrant a linear extrapolation. Another advantage to the end-user becomes apparent in another scenario wherein chemical sensors, e.g., pH-sensors, are being used. The characteristics of a chemical sensor may be subject to drift (i.e., they may change as a result of aging). If such sensor was calibrated during manufacturing end then stored for a relatively long time, the calibration data may have become obsolete owing to the aging of the sensor, resulting in incorrect values registered by the sensor when in operational use. Ideally, these sensors are calibrated just before operational use as in the invention.

In an embodiment of the method, the transponder has a memory, and the method comprises: supplying the value for storing the value in the memory; and causing the transponder to store into the memory a reading of the sensor as associated with the value. In this embodiment, the transponder itself stores the calibration data. During operational use, the readings from the sensor are stored in the memory and can be uploaded, together with the calibration data. Alternatively, the calibration is carried out at the transponder itself and, when questioned, the transponder submits calibrated data to the operator.

In another embodiment, the method comprises: storing the value in a database external to the transponder; and causing the transponder to submit a reading of the sensor and storing the reading in the database as being associated with the value. In this scenario, the calibration is carried out external to the transponder. Once a sensor reading from a particular transponder can be tied to a reference value, or once multiple readings can tied to multiple sensor readings, these ties can be used later on for calibration of further sensor readings submitted by the transponder. The transponder may have a memory for storing readings from the sensor at different times. Alternatively, the transponder only buffers a sensor reading, one at a time, before the transponder's submitting of the reading to an external agent. The data in the database then enable to calibrate the reading.

The invention is in particular interesting to transponders that have sensors with a characteristic that is susceptible to drift. As the calibration can be done if and when needed in operational use, the drift can be compensated for by means of using recent reference values.

For completeness, it is noted that the process of calibrating a sensor includes: calibrating the sensor's output or calibrating the data supplied by the transponder and being representative of the sensor's output.

Several scenarios are possible depending on the type of tag being used.

A first type of tag has a memory for storing calibration values or a calibration function, and for also storing actual readings of the sensor in operational use. This tag has an onboard power supply, e.g., a battery, and onboard control circuitry for control of the process of generating the readings, e.g., periodically under clock control, for the control of the process of storing the readings, e.g., periodically or selectively in dependence on the value of the preceding reading, and for control of the process of calibrating the readings. Calibrating the sensor's output then uses a memory at the transponder for storing a reference value against which the sensor's output is to be calibrated, as well as the actual sensor reading at the time of calibration and/or a calibration function obtained from the values of sensor reading and reference.

A second type of tag has a memory for storing only the sensor readings. The calibration data for a specific tag of this second type is stored in an external database together with a tag identifier for this specific tag that serves to link the calibration data to this specific tag. Calibrating the data supplied by the transponder uses a memory external to the transponder and storing the measurement data supplied by the transponder at the time of calibration, the reference value associated with this individual transponder, and a unique identifier associated with this individual transponder. In the latter scenario, one can manage a batch of transponders in operational use while using a centralized memory for the calibration values. In this manner a scenario is feasible wherein the transponder does not require an individual programmable or re-programmable memory for storing an individual reference value for its calibration. The transponder can thus be made even less expensive.

A third type of tag does not have a memory. The calibration data for a specific tag of this third type is stored in an external database, together with the tag's identifier. Individual readings from the tag's sensor are accumulated and stored in the database during operational use. That way no memory is needed at the tag at all. In a specific embodiment, the tag is a passive tag in the sense that it does not have an onboard battery but is powered through an incident electromagnetic field. This configuration reduces costs, but also reduces functionality (readings can only be stored if an external read/write unit is available)

Above types provide different manners to distribute the functionalities of calibrating and storing calibration parameters and sensor readings. What they do have in common within the context of the invention is that these tags comprise a sensor that can be calibrated in an environment of operational use of the tag, the calibrating using as a reference a value of a parameter representative of the environment.

As to sensors, the method of the invention is in particular, but not exclusively, interesting to scenarios, wherein the sensor comprises at least one of: a chemical sensor for sensing a presence of a chemical in a vicinity of the sensor in the environment, a temperature sensor for sensing a temperature in the vicinity, a pH sensor for sensing an acidity or a basicity in the vicinity, and a humidity sensor for sensing humidity in the vicinity.

### BRIEF DESCRIPTION OF THE DRAWING

The invention is explained in further detail, by way of example and with reference to the accompanying drawing, wherein:

FIG. 1 is a block diagram of a transponder used in the invention;

FIG. 2 is a process diagram to illustrate the sensor calibration in the invention; and

FIGS. 3-5 are diagrams illustrating some scenarios of sensor calibration.

### DETAILED EMBODIMENTS

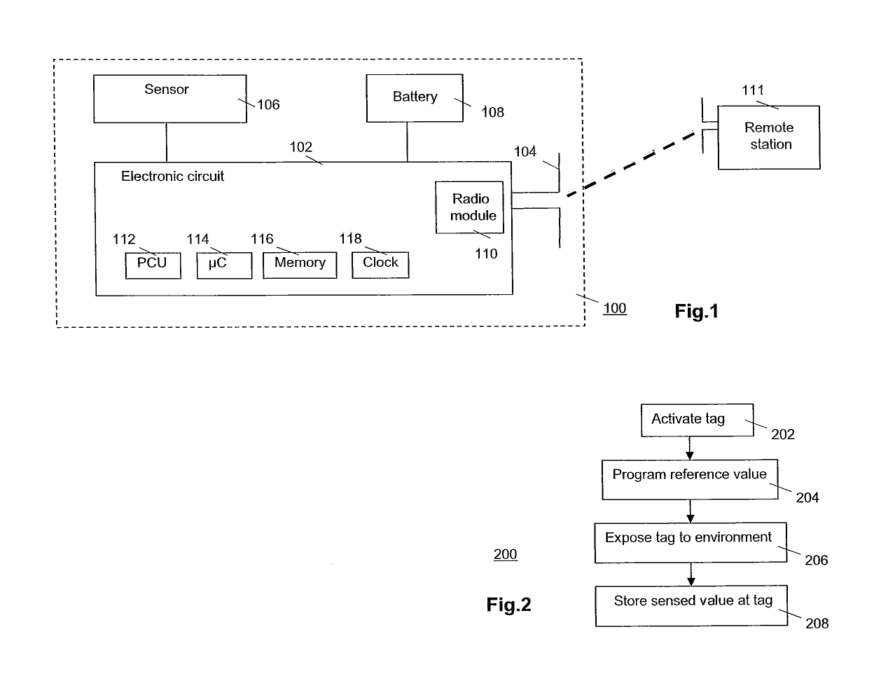

FIG. 1 is a diagram of the main components of a transponder device 100, for example, an active RFID tag. Tag 100 comprises an electronic circuit 102, and antenna 104, a sensor 106 and a power supply 108 such as a battery. Tag 100 is drawn as composed of separate components for clarity. It is understood that the components may be physically integrated with one another, e.g., sensor 106 and/or battery 108 may also be physically integrated with electronic circuit 102 into the same die. Circuit 102 includes a radio module 110 for sending data to, and/or receiving data from, a remote reading/programming station 111, a power control unit (PCU) 112, a microprocessor or microcontroller 114, a memory 116 and an optional clock 118, e.g., an LC-circuit or a quartz crystal oscillator. Preferably, station 111 communicates with device 100 using a wireless connection, e.g., using a radio-frequency communication technology. The configuration and operation of tag 100 is well known in the art and is further not discussed here in great detail.

In supply chain monitoring, tag 100 is attached, implanted, inserted or otherwise fabricated on an item or the item's packaging in order to monitor the environment, to which the individual item has been exposed. For example, tag 100 is attached to the packaging of an item of perishable food, and sensor 106 measures the temperatures to which the item has been exposed over time. Another type of sensor 106 is used to sense the item's exposure to, e.g., one or more specific chemicals in the immediate environment of the item, levels of humidity, levels of intensity of incident light, accelerations, or other physical and/or chemical or quantities.

In the example of active tag 100, microcontroller 114 controls the storage of data supplied by sensor 106 in memory 116, e.g., at regular intervals under control of clock 118. Alternatively, microcontroller stores the data supplied by sensor 106 when sensor 106 has been made temporarily active through a signal supplied by, e.g., station 111, and received by antenna 104. Instead of an active tag 100, a passive tag can be used in a similar manner. A passive tag does not have a local power supply, in contrast with the tag 100, which has battery 108. The passive tag has circuitry similar to circuitry 102, but is powered by the electromagnetic energy received via antenna 104. Configuration and operation of passive tags are well known in the art, and need not be discussed in further detail here. Although the invention is discussed herein with reference to active tag 100, the invention is equally applicable to passive tags.

In the invention, sensor 106 is calibrated in an environment of operational use of the tag 100. That is, the calibrating uses as a reference a value of a parameter representative of the very environment wherein tag 100 is being used by the end-user. The reference parameter includes, e.g., a concentration of a chemical (a so-called analyte) present in the environment, a temperature, the amount of light incident on the sensor, a level of humidity, etc. The calibration process is explained with reference to FIG. 2.

FIG. 2 is a process diagram 200 of a first embodiment of a calibration process of the invention. In a step 202, circuitry 102 is activated. In a step 204, the value of the reference parameter, as obtained in a separate measurement by an accurate measuring device (not shown), is programmed into memory 116 via station 111. For example, sensor 106 comprises a temperature sensor for sensing the temperature at the location of sensor 106 and the reference value is obtained by a calibrated thermometer in a warehouse storing frozen foods. In a step 206, sensor 106 is exposed to the environment or analyte that shall be monitored. For example, sensor 106 (together with the rest of tag 100) is put it into a bag with frozen goods. After a predefined (programmed) time, during which sensor 106 has stabilized, a reading is obtained from sensor 106, and stored in memory 116. This stored reading can now be used together with the programmed reference value for the calibration of further measurements.

Certain modifications can be made to the scenario illustrated by diagram 200. For example, tag 100 is exposed to the environment or analyte prior to programming the actual reference value. As another example, initiation of the reading of sensor 106 is controlled from external station 111 via an RF link if no internal clock is available at transponder 100 due to cost, power consumption or other reasons. However, an internal clock is preferably included in tag 100 for most applications since readings of sensor 106 need to be timed during the subsequent period when the product, to which tag 100 is attached, is being monitored. External station 111 could also do part of the data processing and send a calibration file back to tag 100. As still another example, several readings can be obtained in a certain time interval. This is particularly useful for sensors whose characteristics are subject to drift and need time to stabilize (e.g., pH or chemical sensors). Given the physical/chemical variable does not change, the final value can be extrapolated from the temporal evolution of measurements and be used for calibration. In this manner, drift artifacts are minimized. As still another example, the technique of the invention is, in principle, also applicable to calibration with more than one reference point. For example a temperature sensor tag is calibrated first at a certain temperature right after the preparation of a product, e.g., a food item, and a second time when it is frozen. The temperatures of the item at both time instances are known and programmed into tag 100. The timing for the calibration measurements can again be controlled with an internal clock or triggered via an RF signal from station 111.

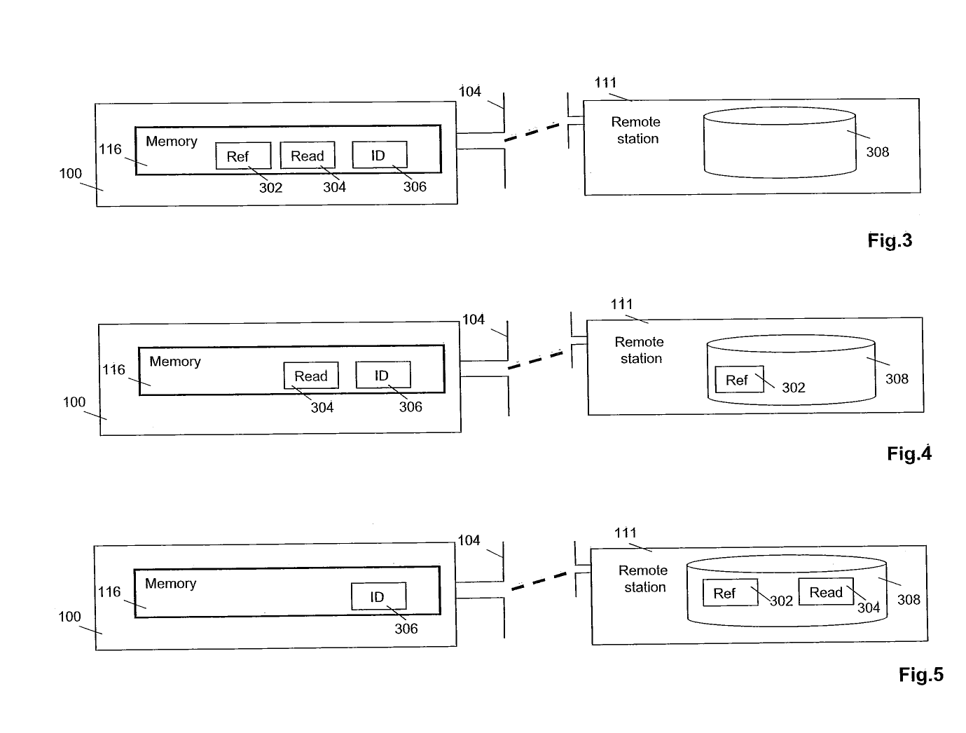

FIGS. 3, 4 and 5 are diagrams illustrating above scenarios in more detail. For clarity, only memory 116 is shown as accommodated in tag 100. All other components shown in tag 100 of FIG. 1 are not explicitly shown, but are deemed present if needed for the relevant one of the scenario being discussed.

FIG. 3 illustrates the scenario, wherein memory 116 stores a reference value or a reference curve 302 as programmed into memory 116 via external station 111. For example, station 111 obtains from an accurate measuring device (not shown) one or more reference values 302 of the parameter that sensor 106 is deemed to measure. The reference value is measured by the measuring device in the same environment as wherein tag 100 resides in operational use. At the time of programming reference value 302 into memory 116, station 111 instructs tag 100 to also store a reading 304 of sensor 106. Reading 304 is stored as associated with reference value 302, e.g., by means of storing the same time stamp for both reference 302 and reading 304 under control of controller 114, or by means of storing them at specific addresses of memory 116 under control of controller 114. As to the latter, the specific addresses then indicate that reference value 302 and reading 304 are temporally related. Later on, a discrepancy between reference value 302 and reading 304 is representative of the correction to be applied when calibrating the other readings of sensor 106. The other readings may be stored in memory 116 as well, e.g., with proper time stamps or periodically with a predetermined time period so as to be able to reconstruct the history of the readings from sensor 106. Memory 116 also stores an identifier of tag 100 so as to be able to distinguish the readings from the sensors from different tags when interrogating tag 100 and other tags via remote station 111 and storing the results in a database 308.

FIG. 4 illustrates the scenario, wherein one or more reference values 302 are stored in database 308. Reference value 302 is, or reference values 302 are to be used with the sensors of all tags, including sensor 106 of tag 100, that are present in the environment to be monitored. To this end, a relationship has to be established between reference value 302 and the individual readings of the sensors of all tags in the monitored environment. Again, this could be implemented by associating, under control of microcontroller 114, a time stamp with the particular readings, e.g., reading 304 of sensor 106 in tag 100, at the time of determining reference value 302. The temporal relationship then binds the particular readings with the reference for calibrating other readings later on. Alternatively, this relationship could be created by means of storing these particular readings, e.g., reading 304, at specific addresses in the memories of the tags. The binding between reference value 302 and the particular readings such as reading 304, is then determined on the basis of the specific memory addresses. As yet another alternative, station 111 instructs tag 100 to communicate sensor reading 304 to station 111 at the time of determining reference value 302. The combination of reading 304 and reference value 302, or multiple combinations of different readings 304 and different reference values 302, are then stored in database 308 per identifier 306 of the tags. Again, this enables to calibrate the sensor readings, stored in memory 116 during operational use, later on.

FIG. 5 illustrates the scenario, wherein memory 116 only stores identifier 306. Calibration data, in the form of one or more combinations of sensor reading and reference value 302, are formed as discussed above with reference to FIG. 4. Instead of storing the readings at memory 116, the readings from sensor 106 are communicated to station 111 together with identifier 306. The communication may be controlled by onboard controller 114. Alternatively, tag 100 in the scenario of FIG. 5 does not have a battery and is a passive tag that receives the energy for communication through incident electro-magnetic waves from station 111. Once tag 100 is thus powered, controller 114 determines the reading of sensor 106 at that moment, and controls the communication thereof, together with identifier 306, to station 111 for storage. In this example, memory 116 only needs to store identifier 306 during operational use of sensor 106. Circuitry 102 in this example needs, in terms of storage, a buffer for temporarily storing the current sensor reading for having it communicated to station 111.

1. Method of calibrating a sensor electrically connected to transponder, wherein the method comprises calibrating the sensor in an environment of operational use of the transponder, the calibrating using as a reference a value of a parameter representative of the environment at the time of calibrating.

2. The method of claim 1, wherein the transponder has a memory, and wherein the method comprises:
supplying the value for storing the value in the memory; and
causing the transponder to store into the memory a reading of the sensor as associated with the value.

3. The method of claim 1, wherein the method comprises:
storing the value in a database external to the transponder; and
causing the transponder to submit a reading of the sensor and storing the reading in the database as being associated with the value.

4. The method of claim 3, wherein the transponder has a memory for storing readings from the sensor at different times.

5. The method of claim 1, wherein the sensor has a characteristic that is susceptible to drift.

6. The method of claim 1, wherein the transponder comprises an RFID tag.

7. The method of claim 1, wherein the sensor comprises at least one of: a chemical sensor for sensing a presence of a chemical in a vicinity of the sensor in the environment, a temperature sensor for sensing a temperature in the vicinity, a pH sensor for sensing an acidity or a basicity in the vicinity, and a humidity sensor for sensing humidity in the vicinity.
